(19) United States
(12) Patent Application Publication
(10) Pub. No.: US 2009/0140196 A1
(43) Pub. Date: Jun. 4, 2009

(54) FLUID PRESSURE DEVICE AND MANUFACTURING METHOD FOR FLUID PRESSURE DEVICE

(75) Inventors: Keiichi MINEGISHI, Saitama-shi (JP); Yasunori Yoshida, Toride-shi (JP); Kouji Wada, Kashiwa-shi (JP); Youichi Kawamura, Tsukubamirai-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SMC Kabushiki Kaisha, Tokyo (JP)

(21) Appl. No.: 12/271,323

(22) Filed: Nov. 14, 2008

(30) Foreign Application Priority Data
Dec. 4, 2007 (JP) 2007-313879

(51) Int. Cl. F16K 7/12; B23P 15/00

(52) U.S. Cl. 251/331; 29/890.14

(57) ABSTRACT

A manufacturing method for a fluid pressure device and a fluid pressure device are provided, in which joints are diffusion bonded to a valve body. In the fluid pressure device, the joints are inserted into an inlet port and an outlet port formed in the valve body, and heating is performed to generate a temperature difference between the valve body and the joints, whereupon by diffusion bonding of the joints into a wall of the valve body in which the inlet port and the outlet port are formed, both members are bonded.

### BACKGROUND OF THE INVENTION

1. Field of the Invention

The present invention relates to a fluid pressure device as well as to a method for manufacturing a fluid pressure device, in which a joint is bonded to a port of a valve body. More specifically, the present invention concerns a fluid pressure device and manufacturing method therefor, in which a joint is diffusion bonded to the valve body.

2. Description of the Related Art

Heretofore, for example, as a fluid pressure device, a pipe joint is known including a socket and a coupler, which are capable of attachment to and detachment from each other. In such a pipe joint, the socket and coupler are disposed coaxially, whereby a fluid passage is formed thereinside through which a pressure fluid can flow, and a valve plug is disposed in the socket displaceably along an axial direction within the fluid passage. Further, a spring is provided in the socket between the valve plug and an inner wall surface of the socket, such that the valve plug is biased toward the side of the coupler, and is seated on a valve seat that faces the fluid passage. After connection of the coupler into the socket, the valve plug is pressed in opposition to an elastic force of the spring, so that the valve plug separates from the valve seat, and thereby communicates with the fluid passage. (See, for example, Japanese Laid-Open Patent Publication No. 2005-344918.)

In this type of fluid pressure device, pipe joints are bonded to ports formed in the valve body by any of screw attachment, fusion welding, or brazing. In a fluid pressure device 100 shown in FIG. 8, a pipe joint 106 is inserted into a port 104, which is formed in a valve body 102, and the pipe joint 106 is fusion welded at an opening of the port 104 of the valve body 102, whereby a fusion weld portion 108 is formed.

However, as shown in FIG. 8, in the event that the diameter of the port 104 and the diameter of the pipe joint 106 are not equal, when the pipe joint 106 is inserted into the port 104, the respective axes of the port 104 and the pipe joint 106 do not coincide with each other, and a gap 110 is formed between both members. Accordingly, fluid tends to be retained within the gap 110, and further, a concern exists in that it becomes difficult to assure a sufficient joint strength. In particular, when the valve body 102 and the pipe joint 106 are fusion welded, a spindle (not shown) may first be inserted into the port 104, whereby positioning of the pipe joint 106 is performed. However, even when such a spindle is used, gaps 110 are generated and cannot be avoided. Furthermore, in the case of fusion welding, blow holes and pits are generated, and further, other problems result, such as the formation of welding defects including abnormal fusing or the like. Still further, it is necessary for the burner of a fusion welding tool to be brought into proximity with the fusion weld portion 108, although to a certain degree, a space should exist and remain between the burner and the fusion weld portion 108. Accordingly, in the case that a pipe joint 106 formed by a short coupler is to be fusion welded onto the valve body 102, a problem results from that the coupler of the pipe joint 106 approaches the valve body 102 too closely, whereby it becomes difficult for such welding operations to be carried out.

### SUMMARY OF THE INVENTION

An object of the present invention is to provide a fluid pressure device, as well as a manufacturing method for a fluid pressure device, which takes into consideration the problems noted above, in which retention of fluids is made as small as possible by diffusion bonding of a joint onto a valve body, wherein the occurrence of welding defects can be avoided, and the joint can easily be joined to the valve body, even in the case of a joint formed by a short coupler.

The method for manufacturing a fluid pressure device according to the present invention, in which a joint is bonded to a port formed in a valve body, comprises the steps of inserting the joint inside of the port, and applying heating so that a temperature difference is developed between the valve body and the joint, so that the joint becomes diffusion bonded with the valve body.

In this case, it is preferable that the step of inserting the joint inside of the port further includes the step of pressing the joint under a condition in which a heated temperature of the valve body is higher than a heated temperature of the joint.

Further, a wire may be disposed between an end in the pressing direction of the joint and a wall of the valve body that forms the port, the wire being pressed by the joint while undergoing diffusion bonding.

In the fluid pressure device of the present invention, a joint is bonded to a port formed in a valve body, wherein the joint, which is inserted inside of the port, is diffusion bonded with the valve body. In this case, it is preferable that an end of the joint is diffusion bonded with the valve body through a wire disposed in the port, since the joint is bonded to the valve body effectively.

According to a fluid pressure device and a manufacturing method for a fluid pressure device, the joint is inserted into the port in the valve body, and heating is performed to generate a temperature difference between the valve body and the joint, whereupon by diffusion bonding of the joint into the valve body, both members can be bonded with high accuracy. As a result, airtightness or liquidtightness at the bonding portion can be improved, and retention of fluids can also be as small as possible. Therefore, a fluid pressure device with high durability can be obtained.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a vertical cross sectional view of a fluid pressure device according to an embodiment of the present invention;

FIG. 2 is a vertical cross sectional view showing a valve open state of the fluid pressure device shown in FIG. 1;

FIG. 3 is an explanatory diagram of a case in which a valve body is heated to a high temperature with respect to a joint by means of high frequency induction heating;

FIG. 4 is an explanatory diagram of a case in which a joint is heated to a high temperature with respect to a valve body by means of high frequency induction heating;

FIG. 5A and FIG. 5B are partially omitted enlarged cross sectional views showing states in which a joint is diffusion bonded to a valve body;

FIG. 6 is an explanatory diagram concerning heating of a joint and a valve body utilizing a heater;

FIG. 7A is an enlarged cross sectional view with partial omission of a case in which a wire having a circular shaped cross section is arranged for diffusion bonding between a valve body and a joint;

FIG. 7B is an enlarged cross sectional view with partial omission of a case in which a wire having a rectangular shaped cross section is arranged for diffusion bonding between the valve body and the joint; and

FIG. 8 is an enlarged cross sectional view with partial omission of a state in which a joint is joined to a valve body in a conventional fluid pressure device.

### DESCRIPTION OF THE PREFERRED EMBODIMENTS

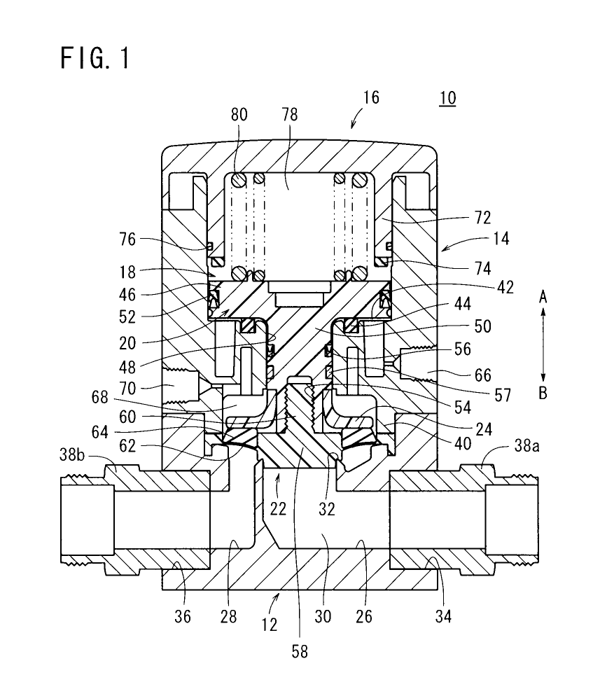

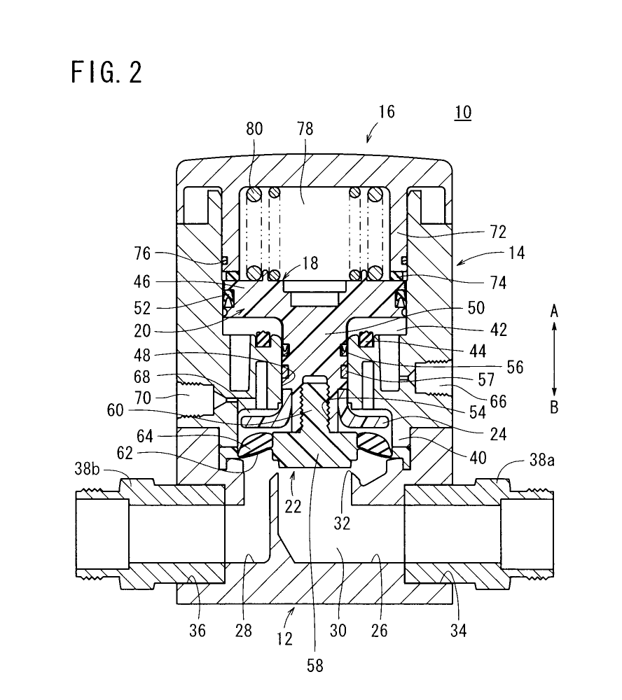

A detailed description concerning an embodiment of the present invention shall be presented below with reference to the accompanying drawings. FIG. 1 is a vertical cross sectional view of a fluid pressure device 10, while FIG. 2 is a vertical cross sectional view showing a valve open state of the fluid pressure device shown in FIG. 1.

As shown in FIGS. 1 and 2, the fluid pressure device 10 is equipped with a valve body 12, a housing 14, a cover 16, and a valve mechanism 18. The valve mechanism 18 includes a piston 20, a valve plug 22 which is screw-engaged with the piston 20, and a ring body 24 that serves to guide a portion of the valve plug 22.

The valve body 12 includes an inlet port 26 through which a pressure fluid is introduced from a non-illustrated pressure fluid supply source, an outlet port 28 through which the pressure fluid is discharged, and a communication passage 30 that provides communication between the inlet port 26 and the outlet port 28. A valve seat 32 on which the valve plug 22 is seated is formed in the communication passage 30.

The inlet port 26 and the outlet port 28 are formed mutually along a straight line sandwiching the communication passage 30 therebetween. An inlet hole 34 is formed on an exterior end of the inlet port 26, and an outlet hole 36 is formed on an exterior end of the outlet port 28. A joint 38a is diffusion bonded in the inlet hole 34, whereas another joint 38b is diffusion bonded in the outlet hole 36.

The upper part of the valve body 12 is formed in a tubular shape. The valve body 12 and the housing 14 are connected together by insertion of an annular shaped lower end 40 of the housing 14 along an inner circumferential surface of the valve body 12.

The upper part of the housing 14 is formed in a tubular shape, with a piston chamber 42 formed therein in which the piston 20 is disposed for displacement along an axial direction, and a shock absorbing member 44 is installed through an annular groove in an end surface of the housing 14 facing the piston chamber 42. Specifically, the piston 20 disposed in the piston chamber 42 is displaced toward the side of the valve body 12 (in the direction of the arrow B), whereupon shocks are buffered by abutment of the lower surface of the piston 20 against the shock absorbing member 44.

The piston 20 is formed with a T-shape in cross section, and is formed by a large diameter portion 46, which abuts against an inner wall surface of the piston chamber 42 in the housing 14, and a small diameter portion 50, which projects downward (in the direction of the arrow B) with respect to the large diameter portion 46, and is inserted through a piston hole 48 formed substantially centrally in the housing 14. A piston packing 52 is mounted through an annular groove on the outer circumferential surface of the large diameter portion 46, whereby an airtight state of the piston chamber 42 is maintained by abutment of the piston packing 52 against the inner wall surface of the piston chamber 42. A screw hole 54 for threaded engagement with the valve plug 22 is formed in a substantially central part of the small diameter portion 50. Further, a piston packing 56 and an o-ring 57 are mounted through annular grooves on the outer circumferential surface of the small diameter portion 50, whereby an airtight state of the piston chamber 42 is maintained by abutment of the piston packing 56 and the o-ring 57 against the piston hole 48.

The valve plug 22 is formed, for example, from a resin material, and is made up from a disk-shaped valve 58 that is seatable on the valve seat 32, a shaft portion 60 that extends in the direction of the arrow A substantially from the center of the valve 58 with screw threads engraved on an outer circumferential surface thereof, and a skirt portion 62 that extends radially outward from an outer edge of the valve 58. An outer edge of the skirt portion 62 is gripped and retained between the valve body 12 and the housing 14.

The ring body 24 includes a cylindrically shaped portion between the valve plug 22 and the piston 20, formed on an outer circumferential side of the shaft portion 60 of the valve plug 22, with the lower end thereof being bent in a radially outward direction substantially in parallel with the skirt portion 62. When the valve plug 22 is displaced, the ring body 24 is capable of displacement integrally with the valve plug 22.

A protective member 64 is disposed between the ring body 24 and the skirt portion 62 of the valve plug 22. The protective member 64 is formed, for example, from an elastic material such as rubber or the like, which is placed in tight contact with the thin-walled skirt portion 62. Owing thereto, in the case that the skirt portion 62 is bent accompanying displacement of the valve plug 22, the skirt portion 62 is protected.

By displacement of the valve plug 22 in the direction of the arrow B, the valve 58 is seated with respect to the valve seat 32 of the valve body 12, resulting in a valve closed state in which communication between the inlet port 26 and the outlet port 28 is interrupted. Conversely, by displacement of the valve plug 22 in the direction of the arrow A, the valve 58 separates from the valve seat 32 of the valve body 12, resulting in a valve open state in which the inlet port 26 and the outlet port 28 communicate through the communication passage 30.

A first port 66 that communicates with the piston chamber 42, and a second port 70 that communicates with a chamber 68 in which the ring body 24 is disposed, are formed in an outer circumferential surface of the housing 14.

A cylindrical portion 72 is formed on an inner side of the cover 16. The housing 14 and the cover 16 are connected together by insertion of the cylindrical portion 72 along an inner circumferential surface on an upper portion of the housing 14. A shock absorbing member 74 is installed in a lower end portion of the cylindrical portion 72. Accordingly, the piston 20 is displaced in the direction of the arrow A, and shocks caused thereby are buffered by abutment of the upper surface of the piston 20 against the shock absorbing member 74. Furthermore, a packing 76 is mounted through an annular groove on an outer circumferential surface of the cylindrical portion 72. The packing 76 abuts against the inner wall surface of the housing 14, whereby an airtight condition of a chamber 78 is maintained. A spring 80, which biases the piston 20, is disposed in the chamber 78 between the cover 16 and the piston 20.

The fluid pressure device 10 according to the embodiment of the present invention is constructed basically as described above. In addition thereto, a joint 38a is diffusion bonded in the inlet hole 34 of the inlet port 26, and a joint 38b is diffusion bonded in an outlet hole 36 of the outlet port 28.

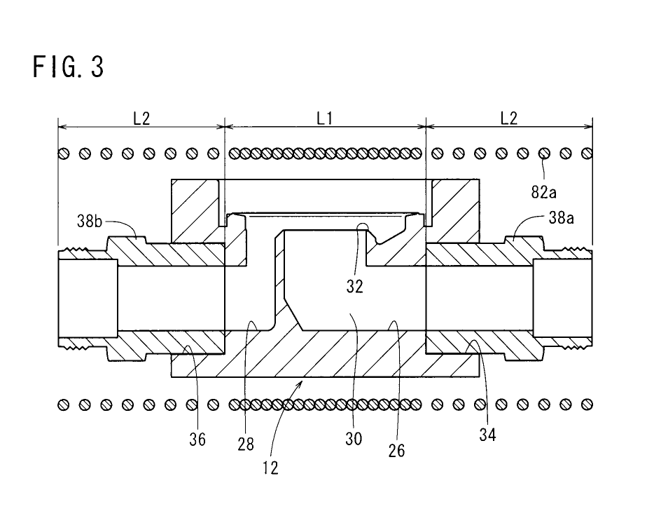

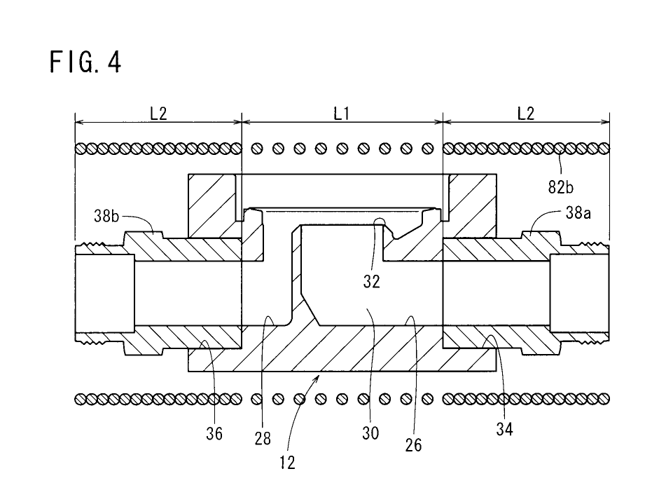

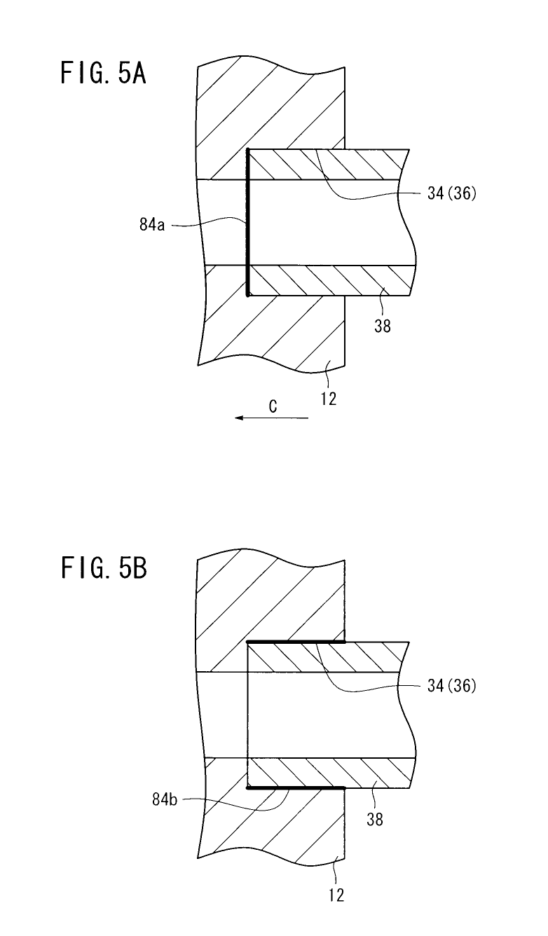

Concerning diffusion bonding of the joints 38a, 38b with respect to the valve body 12, a case exists in which a condition is carried out where the valve body 12 is heated to a high temperature with respect to the joint 38a (38b) (hereinafter referred to simply as “joint (joints) 38”), and another case exists in which a condition is carried out where the joint 38 is heated to a high temperature with respect to the valve body 12. FIG. 3 is an explanatory diagram of a case in which the valve body 12 is heated to a high temperature with respect to the joint 38 by means of high frequency induction heating, and FIG. 4 is an explanatory diagram of a case in which the joint 38 is heated to a high temperature with respect to the valve body 12 by means of high frequency induction heating. Further, FIGS. 5A and 5B are enlarged cross sectional views, with partial omission, of states in which the joint 38 is joined (bonded) to the valve body 12.

In the case that the valve body 12 is heated to a high temperature with respect to the joint 38, as shown in FIG. 3, the valve body 12 with no housing 14 bonded thereto is inserted into a high frequency induction heating coil 82a. Concerning the windings of the coil 82a, the number of windings per unit length of a portion having a distance L1 from the bottom surface portion of the inlet port 26 to the bottom surface portion of the outlet port 28 is greater than the number of windings per unit length of portions having a distance L2 of the joints 38 inserted into the valve body 12. By changing the number of windings in this manner, eddy currents generated at the valve body 12 within the distance L1 are produced in greater magnitude than the eddy currents generated at each of the joints 38 within the distance L2, so that the valve body 12 can be heated to a higher temperature than the joints 38.

When the valve body 12 is heated to a high temperature with respect to the joint 38, an expanded diameter of the inlet hole 34 (outlet hole 36) formed in the valve body 12 becomes greater than the expanded diameter of the joint 38, resulting in a small thermal stress generated between the inner circumferential surface of the inlet hole 34 (outlet hole 36) and the outer circumferential surface of the joint 38. As a result, diffusion bonding does not progress significantly between the inner circumferential surface of the inlet hole 34 (outlet hole 36) and the outer circumferential surface of the joint 38. Owing thereto, by pressing the joint 38 in the direction of the arrow C, diffusion bonding occurs, such that a joint surface 84a is formed between an end of the joint 38 in the direction of the arrow C and a bottom surface of the inlet hole 34 (outlet hole 36), whereby the joint 38 is bonded with respect to the valve body 12 (see FIG. 5A).

In the case that the joint 38 is heated to a high temperature with respect to the valve body 12, as shown in FIG. 4, at a high frequency induction heating coil 82b, the number of windings of the portions having the distance L2 is greater than the number of windings of the portion having the distance L1. By changing the number of windings in this manner, eddy currents generated at the joint 38 within the distance L2 are produced in greater magnitude than the eddy currents generated at the valve body 12 within the distance L1, so that the joint 38 can be heated to a higher temperature than the valve body 12.

When the joint 38 is heated to a high temperature with respect to the valve body 12, an expanded diameter of the joint 38 becomes greater than an expanded diameter of the inlet hole 34 (outlet hole 36) formed in the valve body 12, resulting in a large thermal stress generated between the inner circumferential surface of the inlet hole 34 (outlet hole 36) and the outer circumferential surface of the joint 38. As a result, diffusion bonding occurs so as to form a joint surface 84b between the inner circumferential surface of the inlet hole 34 (outlet hole 36) and the outer circumferential surface of the joint 38, wherein the joint 38 is bonded with respect to the valve body 12 in a highly hermetically sealed state (see FIG. 5B). Accordingly, the joint 38 is capable of being bonded with respect to the valve body 12 without pressing the joint 38 in the direction of the arrow C, as in the aforementioned method in which the valve body 12 is heated to a high temperature with respect to the joint 38.

Furthermore, in the method in which the joint 38 is heated to a high temperature with respect to the valve body 12, it goes without saying that it is also possible to cause a joint surface 84a to be formed between an end of the joint 38 in the direction of the arrow C and a bottom surface of the inlet hole 34 (outlet hole 36), by pressing the joint 38 in the direction of the arrow C as shown in FIG. 5A.

During bonding of the joint 38 to the valve body 12, by providing and establishing a heated temperature difference with respect to the valve body 12 and the joint 38 as described above, the type of diffusion bonded surface can be formed selectively, responsive to the purpose and intended use of the fluid pressure device 10.

Moreover, concerning heating of the valve body 12 and the joint 38, in the case that the valve body 12 and the joint 38 are formed from steel materials, it is necessary that both members be heated to within a range of 800° to 1100° C., while further causing the temperature difference therebetween to be brought into effect.

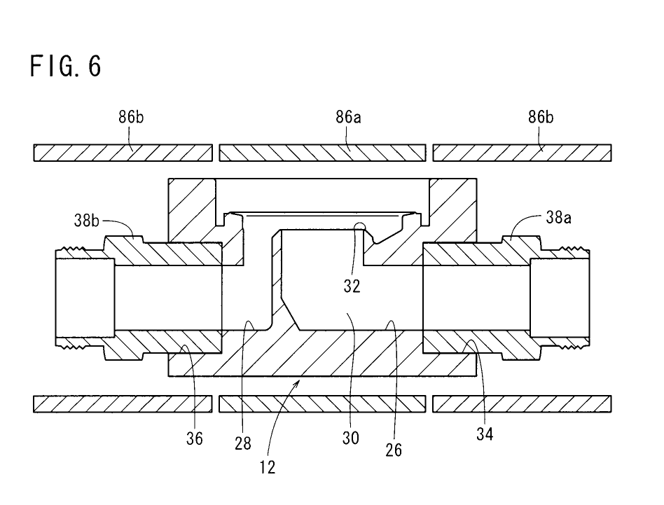

Further, as a heating means for heating the valve body 12 and the joints 38, so long as the temperature difference therebetween can be brought into effect, the invention is not limited to high frequency induction heating, as mentioned previously. For example, as shown in FIG. 6, the valve body 12 and the joints 38 may also be heated by heaters 86a, 86b that produce different heating outputs. In the case that the valve body 12 is heated to a high temperature with respect to the joints 38, the heating output of the heater 86a disposed in proximity to the valve body 12 is made greater than the heating output of the heaters 86b disposed in proximity to the joints 38, whereas in the case that the joints 38 are heated to a high temperature with respect to the valve body 12, the heating output of the heaters 86b disposed in proximity to the joints 38 is made greater than the heating output of the heater 86a disposed in proximity to the valve body 12.

The fluid pressure device 10 according to the embodiment of the present invention is constructed basically as described above. Next, explanations shall be given concerning operations of the fluid pressure device 10.

FIG. 1 shows a valve closed state in which the valve plug 22 is displaced toward the side of the valve seat 32 (in the direction of the arrow B) and communication between the inlet port 26 and the outlet port 28 is interrupted. Further, pipes (not shown) are connected respectively beforehand to the inlet port 26 and to the outlet port 28.

In such a valve closed state, when fluid is supplied to the piston chamber 42 from the first port 66, the piston 20, which is pressed in the direction of the arrow B by the spring 80, is displaced in the direction of the arrow A. Accompanying displacement of the piston 20, the valve plug 22 is displaced in the direction of the arrow A while the skirt portion 62 is subjected to bending, and the valve 58 separates from the valve seat 32, resulting in a valve open state in which the inlet port 26 and the outlet port 28 are placed in communication through the communication passage 30.

In addition, upon further continuing the supply of fluid to the piston chamber 42 from the first port 66, the upper surface of the piston 20 abuts against the shock absorbing member 74 formed on the cylindrical portion 72, resulting in a completely open state in which displacement in the direction of the arrow A of the piston 20 and the valve plug 22 is regulated.

Next, in the above-described valve open state (see FIG. 2), the fluid inside the piston chamber 42 is discharged from the first port 66, whereby the piston 20 is displaced in the direction of the arrow B due to an urging force imposed on the piston 20 from the spring 80. Accompanying displacement of the piston 20, the valve plug 22 is displaced in the direction of the arrow B while the skirt portion 62 is subjected to bending, and the valve 58 is seated with respect to the valve seat 32, resulting in a valve closed state in which communication between the inlet port 26 and the outlet port 28 through the communication passage 30 is interrupted.

As described above, in the fluid pressure device 10 according to the embodiment of the present invention, the joint 38a is inserted inside the inlet port 26 and the joint 38b is inserted inside the outlet port 28, whereupon by applying heating such that a temperature difference is developed between the valve body 12 and the joint 38a (38b), the valve body 12 and the joint 38a (38b) are diffusion bonded. Specifically, a spigot joint structure is provided, in which the joint 38a is inserted inside the inlet port 26 and the joint 38b is inserted inside the outlet port 28, and further, by causing diffusion bonding between the valve body 12 and the joint 38a (38b), both members can be joined together reliably and with high accuracy. Owing thereto, airtightness or liquidtightness can further be enhanced, and the retention of fluids can be avoided. Still further, because the joints 38 are inserted into the inlet hole 34 (outlet hole 36) and diffusion bonding is carried out, even in the case of a joint 38 formed by a short coupler, the joint 38 can be easily joined to the valve body 12. As a result, as the joints 38, joints having various shapes, such as joints formed with flanges, or joints formed by short couplers and the like, are capable of being bonded to the valve body 12.

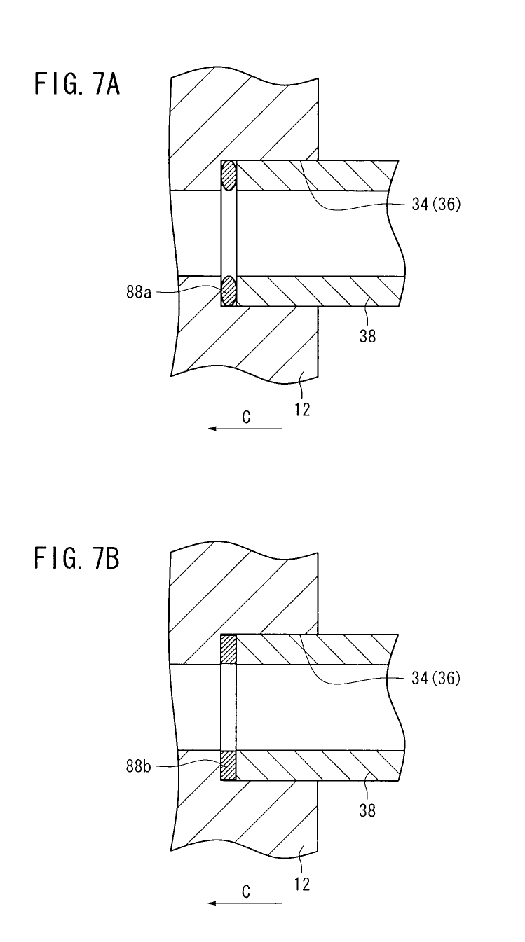

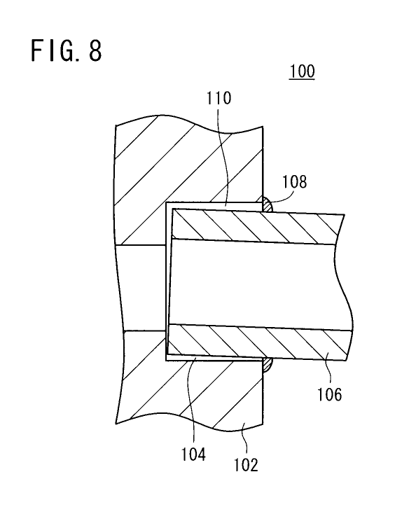

With the above-mentioned fluid pressure device 10, diffusion bonding is performed directly on the valve body 12 and the joints 38. On the other hand, wires may first be arranged between the bottom surfaces (on the wall portion of the valve body 12) of the inlet hole 34 within the inlet port 26 and the outlet hole 36 within the outlet port 28 of the valve body 12, and the joints 38, whereupon diffusion bonding is then carried out. FIG. 7A shows a case wherein a wire 88a having a circular cross section is so arranged, whereas FIG. 7B shows a case wherein a wire 88b having a rectangular cross section is so arranged. By arrangement of the wires in this manner, and pressing the joint 38 in the direction of the arrow C, the valve body 12 and the joint 38 are diffusion bonded through the wires 88a, 88b. In the case that wires 88a having a circular cross section are so arranged, since the contact area between the wire 88a, the valve body 12 and the joint 38 becomes small, stresses are increased and a more reliable diffusion bond is formed.

Further, although the above-described fluid pressure device 10 functions as a two-way valve, as a fluid pressure device in which the valve body and joints are diffusion bonded, the invention is not limited to a two-way valve. For example, a regulator or a filter also may be constructed in accordance with the method of the present invention.

Moreover, although as described above both the valve body 12 and the joints 38 are formed from the same metal materials, metals of different types may also be used. As for the types of metals used, no particular limitation is placed thereon, however, steels, copper alloys, and nickel alloys are preferred.

The present invention is not limited to the aforementioned embodiment, and it is a matter of course that various other structures could be adopted without deviating from the essence and gist of the present invention.

What is claimed is:

1. A method for manufacturing a fluid pressure device, in which a joint is bonded to a port formed in a valve body, comprising the steps of:
inserting the joint inside of the port; and
applying heating so that a temperature difference is developed between the valve body and the joint,
wherein the joint is diffusion bonded with the valve body.

2. The method for manufacturing the fluid pressure device according to claim 1, wherein the step of inserting the joint inside of the port further includes the step of pressing the joint under a condition in which a heated temperature of the valve body is higher than a heated temperature of the joint.

3. The method for manufacturing the fluid pressure device according to claim 2, wherein a wire is disposed between an end in the pressing direction of the joint and a wall of the valve body that forms the port, the wire being pressed by the joint while undergoing diffusion bonding.

4. A fluid pressure device, in which a joint is bonded to a port formed in a valve body, wherein the joint, which is inserted inside of the port, is diffusion bonded with the valve body.

5. The fluid pressure device according to claim 4, wherein an end of the joint is diffusion bonded with the valve body through a wire disposed in the port.
